(19) United States
(12) Patent Application Publication
(10) Pub. No.: US 2026/0313582 A1
(43) Pub. Date: Oct. 8, 2026

(54) REGISTRATION METHOD, AND APPARATUS AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/482,571

(22) PCT Filed: May 9, 2023
(86) PCT No.: PCT/CN2023/093097

§ 371 Date: Nov. 7, 2025

(51) Int. Cl. H04W 60/04; H04W 56/00

(52) U.S. Cl. CPC H04W 60/04; H04W 56/0015

(57) ABSTRACT

A method for wireless registration, including: registering via a relay device, where the relay device is configured to forward a wireless signal between the terminal and a network device, the wireless signal is configured for the terminal to register, and the terminal is an ambient internet of things device.

### CROSS-REFERENCE TO RELATED APPLICATION

The present application is a U.S. National Stage of International Application No. PCT/CN 2023/093097, filed on May 9, 2023, the contents of all of which are incorporated herein by reference in their entirety for all purposes.

### BACKGROUND OF THE INVENTION

With the development of the Internet of Things (IoT) technology, an ambient IoT technology has been proposed in the 3rd Generation Partnership Project (3GPP). Ambient IoT devices can operate without a power supply (pure batteryless devices) or be powered by obtaining energy from the environment, enabling them to support signal transmission.

### SUMMARY OF THE INVENTION

The present disclosure relates to the technical field of communications, and in particular, relates to a method for wireless registration, device, and a storage medium.

According to a first aspect of the embodiments of the present disclosure, a method for wireless registration is provided, which is performed by a terminal. The method includes:
registering via a relay device, where the relay device is configured to forward a wireless signal between the terminal and a network device, the wireless signal is configured for the terminal to register, and the terminal is an ambient internet of things device.

According to a second aspect of the embodiments of the present disclosure, a method for wireless registration is provided, which is performed by a relay device. The method includes:
forwarding a wireless signal between a terminal and a network device, where the wireless signal is configured for the terminal to register.

According to a third aspect of the embodiments of the present disclosure, a method for wireless registration is provided, which is performed by a network device. The method includes:
registering a terminal via a relay device, where the relay device is configured to forward a wireless signal between the terminal and the network device, and the wireless signal is configured for the terminal to register.

According to a fourth aspect of the embodiments of the present disclosure, a terminal is provided, including:
one or more processors; and
a memory that stores processor-executable instructions, where the processor-executable instructions, when collectively executed by the one or more processors, cause the terminal to perform the steps of the method for wireless registration provided in the first aspect of the present disclosure.

According to a fifth aspect of the embodiments of the present disclosure, a relay device is provided, including:
one or more processors; and
a memory that stores processor-executable instructions, where the processor-executable instructions, when collectively executed by the one or more processors, cause the relay device to perform the steps of the method for wireless registration provided in the second aspect of the present disclosure.

According to a sixth aspect of the embodiments of the present disclosure, a network device is provided, including:
one or more processors; and
a memory that stores processor-executable instructions, where the processor-executable instructions, when collectively executed by the one or more processors, cause the network device to perform the steps of the method for wireless registration provided in the third aspect of the present disclosure.

It is to be understood that the above general description and the following detailed description are merely illustrative and explanatory and are not intended to limit the present disclosure.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of a communication system according to an example.

FIG. 2 is a flowchart of a method for wireless registration according to an example.

FIG. 3 is a flowchart of a method for wireless registration according to an example.

FIG. 4 is a flowchart of a method for wireless registration according to an example.

FIG. 5 is a flowchart of a method for wireless registration according to an example.

FIG. 6 is a flowchart of a method for wireless registration according to an example.

FIG. 7 is a flowchart of a method for wireless registration according to an example.

FIG. 8 is a flowchart of a method for wireless registration according to an example.

FIG. 9 is a flowchart of a method for wireless registration according to an example.

FIG. 10 is a flowchart of a method for wireless registration according to an example.

FIG. 11 is a flowchart of a method for wireless registration according to an example.

FIG. 12 is a flowchart of a method for wireless registration according to an example.

FIG. 13 is a flowchart of a method for wireless registration according to an example.

FIG. 14 is a flowchart of a method for wireless registration according to an example.

FIG. 15 is a flowchart of a method for wireless registration according to an example.

FIG. 16 is a flowchart of a method for wireless registration according to an example.

FIG. 17 is a flowchart of a method for wireless registration according to an example.

FIG. 18 is a flowchart of a method for wireless registration according to an example.

FIG. 19 is a flowchart of a method for wireless registration according to an example.

FIG. 20 is a block diagram of a terminal according to an example.

FIG. 21 is a block diagram of a relay device according to an example.

FIG. 22 is a block diagram of a network device according to an example.

FIG. 23 is a block diagram of a communication device according to an example.

### DETAILED DESCRIPTION OF THE INVENTION

Examples will be described in detail here, with examples illustrated in the accompanying drawings. In the following description, when involving the accompanying drawings, unless otherwise indicated, the same numerals in different drawings represent the same or similar elements. The implementations described in the following examples do not represent all implementations consistent with the present disclosure. Instead, they are merely examples of devices and methods that are consistent with some aspects of the present disclosure as detailed in the appended claims.

In the description of the embodiments of the present disclosure, terms such as “first” and “second” are configured to distinguish similar objects and do not need to be understood as indicating a specific order or sequence. Additionally, unless otherwise specified, in the description referencing the accompanying drawings, the same numerals in different drawings denote the same element.

In the description of the embodiments of the present disclosure, unless otherwise specified, “a plurality of” means two or more, and other quantifiers are similar. “At least one,” “one or more,” or similar expressions refer to any combination of these items, including any combination of single or multiple items. For example, “at least one” can mean any number; for another example, “one or more of a, b, and c” can mean: a, b, c, a-b, a-c, b-c, or a-b-c, where a, b, c may be singular or may also be plural. “And/or” is a description of an association relationship between associated objects, indicating three possible relationships. For example, “A and/or B” may mean: A exists alone, A and B exist together, or B exists alone, where A and B may be singular or plural. The character “/” indicates an “or” relationship between the associated objects before and after it. Singular forms “one,” “a,” “an,” “this,” “the,” “above-mentioned,” and “aforementioned” are also intended to include plural forms, unless the context clearly indicates otherwise.

In the description of the embodiments of the present disclosure, phrases such as “A in one case, and B in another case” and “A, in response to one case, and B in response to another case” may include the following technical solutions depending on the situation: A is performed regardless of B, i.e., A, in some embodiments; B is performed regardless of A, i.e., B, in some embodiments; A and B are selectively performed, i.e., A and B are selected to be performed in some embodiments; both A and B are performed, i.e., A and B, in some embodiments. Similar logic applies in a case where more branches, such as A, B and C, are involved.

In the description of the embodiments of the present disclosure, “including A,” “comprising A,” “for indicating A,” and “carrying A” may be interpreted as directly carrying A or may also be interpreted as indirectly indicating A.

In the description of the embodiments of the present disclosure, terms such as “in response to ... ,” “in response to determining ... ,” “in a case where ... ,” “upon ... ,” “when ... ,” “in a case of ... ,” “providing ...” can be used interchangeably.

In some embodiments, terms such as “greater than,” “greater than or equal to,” “above,” “higher than,” and “not less than” can be used interchangeably, and terms “less than,” “less than or equal to,” “below,” “lower than,” and “not greater than” can be used interchangeably.

In the description of the embodiments of the present disclosure, terms such as “network element,” “node,” “function,” “device,” “equipment,” “system,” “chip,” and “chip system” can be used interchangeably.

In the description of the embodiments of the present disclosure, the names of messages or information exchanged among a plurality of devices are merely for illustrative purposes and are not intended to limit the scope of these messages or information.

Furthermore, each element, each row, or each column in tables of the embodiments of the present disclosure can be implemented as an independent embodiment, and any combination of elements, rows, or columns can also be implemented as an independent embodiment.

Although operations or steps are described in a specific order in the embodiments of the present disclosure or the accompanying drawings, it is not to be understood as demanding that these operations or steps are performed in a specific order shown or in a serial order, or that all the operations or steps shown are performed to obtain a desired result. In the embodiments of the present disclosure, these operations or steps can be performed in any order, in parallel, or partially, without any contradiction; and operations or steps in a plurality of embodiments or accompanying drawings can also be combined in any way, which is not limited to the embodiments of the present disclosure.

It is to be noted that the embodiments of the present disclosure are not exhaustive and are merely illustrative of some embodiments, without imposing specific limitations on the scope of the present disclosure. Without any contradiction, each step in a certain embodiment can be implemented as an independent embodiment, and various steps can be combined in any order. For example, a solution in which some steps are removed from a certain embodiment can also be implemented as an independent embodiment, and the order of various steps in a certain embodiment can be exchanged arbitrarily. Additionally, optional implementations in a certain embodiment can be combined in any way. Furthermore, different embodiments can be combined in any way. For example, some or all steps of different embodiments can be combined in any way, and a certain embodiment can be combined with optional implementations of other embodiments.

The following will introduce the implementation environment of the embodiments of the present disclosure first.

The technical solutions of the embodiments of the present disclosure can be applied to various communication systems. The communication system may include one or more of the 4th generation (4G) communication systems, the 5th generation (5G) communication systems, and other future wireless communication systems (such as 6G). The communication system may also include one or more of a public land mobile network (PLMN), a device-to-device (D2D) communication system, a machine-to-machine (M2M) communication system, an internet of things (IoT) communication system, a vehicle-to-everything (V2X) communication system, or other communication systems.

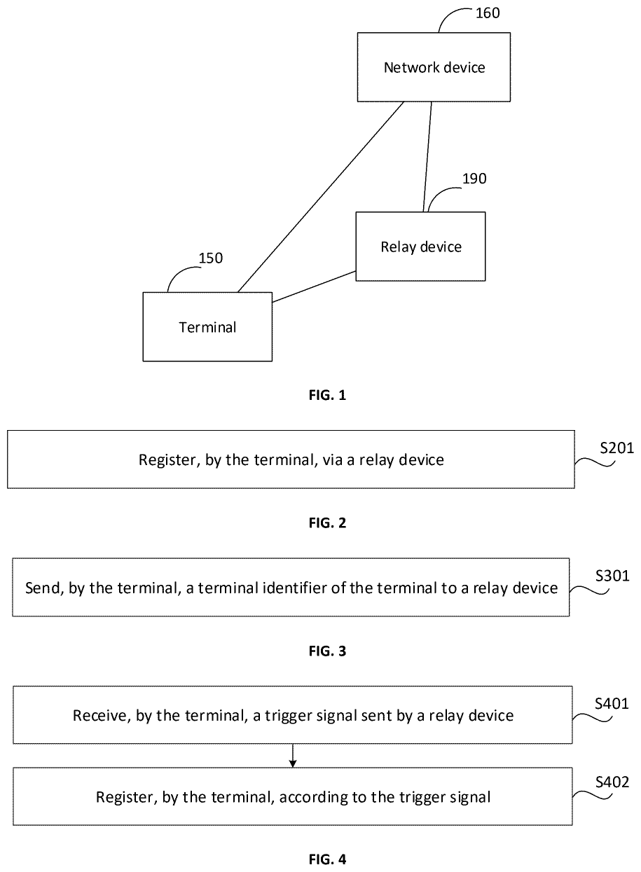

FIG. 1 is a schematic diagram of a communication system 100 according to an example. As shown in FIG. 1, the communication system 100 may include a terminal 150, a network device 160, and a relay device 190. The communication system can be configured to support a 4G network access technology, such as a long-term evolution (LTE) access technology, or a 5G network access technology, such as a new radio access technology (New RAT), or other future wireless communication technologies. It is to be noted that the quantities of the network device, the terminal, and the relay device in the communication system may be one or more. The quantities of the network device, the terminal, and the relay device of the communication system shown in FIG. 1 are merely for illustrative purposes and are not limited to the present disclosure.

The network device in FIG. 1 can be configured to support the terminal in communication. For example, the network device may include an evolved Node B (eNB or eNodeB) in LTE. The network device may also include the next generation Node B (gNB or gNodeB) in a 5G network, may also include an NG-radio access network (NG-RAN) device in the 5G network, or may also include at least one of a base station in a future evolved public land mobile network (PLMN), a broadband network gateway (BNG), an aggregation switch, or a non-3GPP access device. Optionally, the network device in the embodiments of the present disclosure may include at least one of various types of base stations, such as a macro base station, a micro base station (also known as a small cell), a relay station, an access point, a 5G base station or a future base station, a satellite, a transmitting and receiving point (TRP), a transmitting point (TP), a mobile switching center, or other devices that perform base station functions in device-to-device (D2D), machine-to-machine (M2M), internet of things (IoT), and vehicle-to-everything (V2X) communication systems, which are not specifically limited in the embodiments of the present disclosure. For convenience of description, devices providing wireless communication functions to the terminal in the embodiments of the present disclosure are collectively referred to as network devices or base stations.

In some embodiments, the network device may include an access network device and a core network device.

The relay device in FIG. 1 may be configured to facilitate communication between the terminals and the network device. In some embodiments, the relay device may forward a wireless signal between the terminal and the network device, where the wireless signal may be configured for the terminal to register, or may also be configured for communication between the terminal and the network device. For example, the relay device may forward a wireless signal sent by the network device to the terminal, or may also forward a wireless signal sent by the terminal to the network device.

The relay device may be an independent device, or may also be a component or module integrated into the network device, or may also be a terminal with a relay function.

In some embodiments, the relay device, as an independent device, may be connected to the network device in a wired or wireless manner.

In some embodiments, the relay device may include a radio-frequency read/write device, and the radio-frequency read/write device may communicate with the terminal based on a radio-frequency read/write manner, and communicate with the network device based on a wireless or wired manner, enabling communication between the terminal and the network device. For example, the radio-frequency read/write device may write information to or read from the terminal based on a radio-frequency read/write manner.

In some embodiments, the relay device is connected to the network device in a wired or wireless manner, or the relay device is integrated into the network device.

For example, the relay device may include: a radio-frequency read/write device connected to the network device in a wired manner, a radio-frequency read/write device connected to the network device in a wireless manner, or a radio-frequency read/write device integrated into the network device.

In some embodiments, the relay device may be configured to perform at least one of:
reading information stored in the terminal based on a radio-frequency read/write manner;
writing information to the terminal based on a radio-frequency read/write manner;
sending a wireless signal to the terminal;
receiving a wireless signal sent by the terminal;
receiving a wireless signal sent by the network device;
responding to the wireless signal sent by the network device; or
sending a wireless signal to the network device.

It is to be noted that the relay device may also be referred to as a transit node, transit device or relay node.

The terminal in FIG. 1 may be an electronic device providing voice or data connectivity. For example, the terminal may also be referred to as user equipment (UE), a subscriber unit, a mobile station, a station, a terminal, etc. For example, the terminal may include a smartphone, a smart wearable device, a smart speaker, a smart tablet, a wireless modem, a wireless local loop (WLL) station, a personal digital assistant (PDA), customer premise equipment (CPE), etc. With the development of wireless communication technology, devices that can access a communication system, communicate with a network device of the communication system, communicate with other objects via the communication system, or devices that can directly communicate between two or more devices all can be terminals in the embodiments of the present disclosure, such as a terminal and a car in intelligent transportation, a household device in smart home, power metering instrument, voltage monitoring instrument, environmental monitoring instrument in smart grid, video monitoring instrument in a smart security network, and a cash register. In the embodiments of the present disclosure, the terminal can communicate with the network device, and also can communicate with the network device via the relay device. A plurality of terminals can also communicate with each other. The terminal may be static and fixed or may also be mobile, which is not limited to the embodiments of the present disclosure.

In some embodiments of the present disclosure, the terminal in FIG. 1 may include an ambient IoT device. Compared to an ordinary IoT terminal, the ambient IoT device can have a simpler structure and lower hardware and maintenance costs. The ambient IoT device may be a passive device, for example, without a battery or other energy storage components. The ambient IoT device may also be an active device, for example, equipped with a battery or other small-capacity energy storage components, which can be replaceable or non-replaceable. The ambient IoT device may also be a semi-passive device, for example, containing a non-replaceable energy storage component. In some embodiments, the ambient IoT device may obtain energy from an environment, for example, solar energy, wind energy, thermal energy, hydro energy, or electromagnetic energy from the environment can be converted into the energy of the device, so that signal transmission is enabled based on the obtained energy.

The form of the ambient IoT device may be an electronic tag, such as a card-type electronic tag, a capsule-type electronic tag, a patch-type electronic tag, or a ring-type electronic tag. These electronic tags can be applied on a large scale. For example, each item can be attached to one electronic tag. The electronic tag can meet the needs for low cost, small size, low power consumption, and other aspects. It is to be noted that the ambient IoT device may also be other forms of integrated terminals. These integrated terminals are designed according to specific environments or specific operating conditions, and are capable of adapting to various harsh operating environments and performing more complicated communication tasks.

It is to be noted that the ambient IoT device may also be referred to as an ambient power-enabled IoT device, a zero-power-consumption IoT device or a tag.

The ambient IoT device is simple in structure and needs to register first for communication. How to achieve the registration of the ambient IoT device has become an urgent problem that needs to be solved.

FIG. 2 is a flowchart of a method for registering according to an example. The method may be performed by a terminal in the above-mentioned communication system. As shown in FIG. 2, the method may include the following step S201.

In step S201, the terminal registers via a relay device.

In some embodiments, the relay device may be configured to forward a wireless signal between the terminal and a network device, where the wireless signal may be configured for the terminal to register.

The terminal may be an ambient IoT device, or may also be other devices capable of communicating with the relay device.

In some embodiments, the terminal may be a passive terminal or a low-power-consumption terminal (for example, it may be a low-power-consumption ambient IoT device, or a passive ambient IoT device). In order to reduce the power consumption and complexity of the terminal, a communication distance that can be supported by the terminal may be less than a distance threshold, where the distance threshold may be any value between 1 meter and 1,000 meters. For example, the distance threshold may be 10 meters, 50 meters, 100 meters or 200 meters.

The terminal may register with the network device via the relay device, or may also communicate with the network device via the relay device, in a case where the communication distance that can be supported by the terminal is less than a distance between the terminal and the network device. Hence, the problem of the terminal being unable to register or communicate due to distance limitations can be solved.

By adopting the above-mentioned method, the terminal may register via the relay device, where the relay device may be configured to forward the wireless signal between the terminal and the network device, the wireless signal may be configured for the terminal to register, and the terminal may be an ambient IoT device. In this way, the registration of the terminal is achieved via the relay device, which can support the terminal to register with the network device that is far away, improving the communication reliability of the terminal.

In some embodiments of the present disclosure, the process of the terminal registering via the relay device may include at least one of the following steps.

The terminal receives a trigger signal sent by the relay device. The trigger signal may be configured to indicate the terminal to perform registration.

The terminal sends a trigger feedback signal to the relay device. The trigger feedback signal may be configured to indicate that the terminal has received the trigger signal.

The terminal sends a device identifier of the terminal to the relay device. The device identifier may be configured to indicate that the relay device forwards the device identifier to the network device.

The terminal receives synchronization information sent by the relay device. The synchronization information may include at least one of time-domain synchronization information or frequency-domain synchronization information.

The terminal sends a synchronization feedback signal to the relay device, where the synchronization feedback signal may be configured to indicate that the terminal has received the synchronization information.

The terminal receives system information sent by the relay device.

The terminal sends a system information feedback signal to the relay device.

In this way, the terminal may register using any one or a combination of the above-mentioned steps.

FIG. 3 is a flowchart of a method for wireless registration according to an example. The method may be performed by a terminal in the above-mentioned communication system. As shown in FIG. 3, the method may include the following step S301.

In step S301, the terminal sends a terminal identifier of the terminal to a relay device.

The terminal identifier may be forwarded by the relay device to a network device. For example, the relay device, upon receiving the terminal identifier, may forward the terminal identifier to the network device.

The terminal identifier may further be configured for the network device to register the terminal. In some embodiments, the terminal identifier may be configured to uniquely identify the terminal. For example, the terminal identifier may include at least one of a subscription concealed identifier (SUCI), a subscriber permanent identifier (SUPI), a globally unique temporary identifier (GUTI), a permanent equipment identifier (PEI), an international mobile equipment identity (IMEI), an international mobile subscriber identity (IMSI), a temporary mobile subscriber identity (TMSI), a radio network temporary Identity (RNTI), or other device identifiers of the terminal.

In some embodiments, the terminal may send a trigger signal to the relay device, where the trigger signal may include the terminal identifier of the terminal.

In other embodiments, the terminal may further send device information of the terminal to the relay device, apart from the terminal identifier. The device information may be configured for registration and may include at least one of: a first type of the terminal (for example, the first type may be a passive terminal, an active terminal, or a semi-passive terminal), a second type of the terminal (for example, the second type may be a paper tag, a metal tag, or other types), a device volume of the terminal, a communication distance of the terminal, a communication delay of the terminal, etc.

In some embodiments, the relay device may forward the terminal identifier to the network device, and the network device may register (e.g., authenticate or authorize), according to the terminal identifier, the terminal.

In this way, the terminal sends the terminal identifier of the terminal to the relay device for registration of the terminal.

FIG. 4 is a flowchart of a method for wireless registration according to an example. The method may be performed by a terminal in the above-mentioned communication system. As shown in FIG. 4, the method may include the following steps S401 and S402.

In step S401, the terminal receives a trigger signal sent by a relay device.

The trigger signal may be configured to indicate the terminal to perform registration.

In step S402, the terminal registers according to the trigger signal.

In some embodiments, the terminal may send, according to the trigger signal, a terminal identifier of the terminal to the relay device.

The terminal identifier may be configured for the network device to authorize and register the terminal.

In other embodiments, the terminal may transmit, according to the trigger signal, the terminal identifier of the terminal to the relay device based on a radio-frequency read/write manner.

In one implementation, the terminal, upon entering a specific area, may report the terminal identifier based on a radio-frequency read/write manner.

In one implementation, the terminal may be a tag, and the relay device may be a radio frequency reader-writer. The terminal may report the terminal identifier of the terminal to the relay device based on a radio-frequency read/write manner.

It is to be noted that the radio-frequency read/write may also be referred to as radio-frequency identification (RFID).

In some embodiments, the terminal may further send a trigger feedback signal to the relay device. The trigger feedback signal may be configured to indicate that the terminal has received the trigger signal.

In this way, the terminal may register according to the trigger signal received.

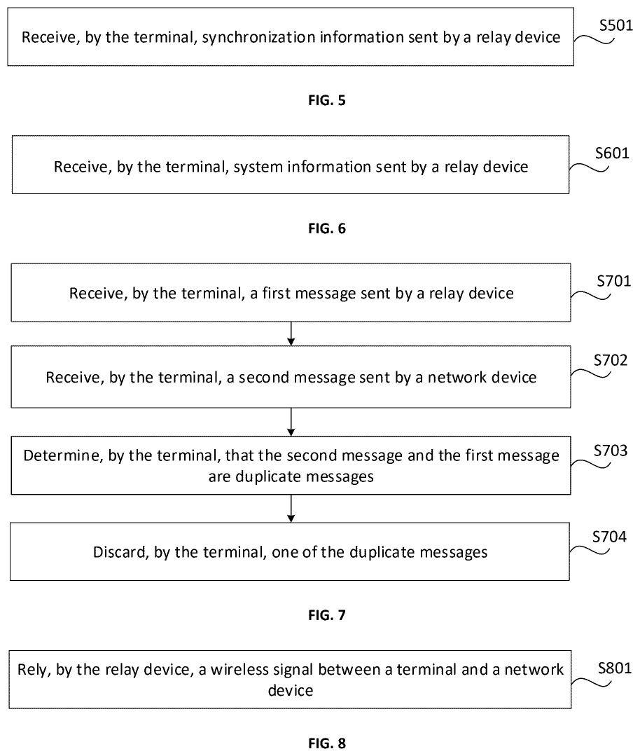

FIG. 5 is a flowchart of a method for wireless registration according to an example. The method may be performed by a terminal in the above-mentioned communication system. As shown in FIG. 5, the method may include the following step S501.

In step S501, the terminal receives synchronization information sent by a relay device.

The synchronization information may include at least one of the time-domain synchronization information or the frequency-domain synchronization information.

In some embodiments, the terminal may synchronize according to the synchronization information. For example, the terminal may perform time-domain synchronization according to the time-domain synchronization information, or may also perform frequency-domain synchronization according to the frequency-domain synchronization information.

In this way, the terminal may synchronize according to the synchronization information to register or communicate.

In some embodiments, the terminal may further send a synchronization feedback signal to the relay device. The synchronization feedback signal may be configured to indicate that the terminal has received the synchronization information.

In one implementation, the terminal, upon completing the synchronization according to the synchronization information, may send the synchronization feedback signal to the relay device, where the synchronization feedback signal may be configured to indicate that the terminal has completed the synchronization.

FIG. 6 is a flowchart of a method for wireless registration according to an example. The method may be performed by a terminal in the above-mentioned communication system. As shown in FIG. 6, the method may include the following step S601.

In step S601, the terminal receives system information sent by a relay device.

The system information may include network information of a network device, where the network information may include at least one of: cell identifier information, frequency information (e.g., center frequency point, frequency bandwidth, whether frequency hopping is supported, etc.), cell selection information, cell reselection information or network capability information (e.g., whether registration or access of an ambient IoT terminal is supported, whether registration or access of a terminal via a relay device is supported, etc.).

In this way, the terminal may register according to the system information.

In some embodiments, the terminal may further send a system information feedback signal to the relay device. The system information feedback signal may be configured to indicate that the terminal has received the system information.

It is to be noted that the above-mentioned embodiments or implementations of FIGS. 3 to 6 and their various optional solutions may be combined with each other, in a case of no contradiction. Some examples are as follows.

In some embodiments, the terminal may first receive synchronization information sent by the relay device, then, after completing synchronization, receive the system information sent by the relay device, and register according to the system information, such as by sending the terminal identifier to the relay device.

In other embodiments, the terminal may first receive synchronization information sent by the relay device, and then register, after completing synchronization, such as by sending the terminal identifier to the relay device.

In yet other embodiments, the terminal may first receive a trigger signal sent by the relay device and send a trigger feedback signal to the relay device. Then, the terminal receives synchronization information sent by the relay device, and then registers, after completing synchronization, such as by sending the terminal identifier to the relay device.

Via any combination of the above-mentioned modes, the terminal may register via the relay device.

FIG. 7 is a flowchart of a method for wireless registration according to an example. The method may be performed by a terminal in the above-mentioned communication system. As shown in FIG. 7, the method may include the following steps S701 to S704.

In step S701, the terminal receives a first message sent by a relay device.

In step S702, the terminal receives a second message sent by a network device.

In step S703, the terminal determines that the second message and the first message are duplicate messages.

It is to be noted that the first message may carry any information or signal, such as synchronization information, system information, a trigger signal or other registration information or signals. Similarly, the second message may also carry any of the above-mentioned information or signals.

In some embodiments, the network device sends the second message, and the relay device, upon receiving the second message, forwards the first message to the terminal (the content of the first message is the same as that of the second message). Both the second message and the first message may be received by the terminal. At this time, the terminal may determine that the second message and the first message are duplicate messages.

It is to be noted that the above-mentioned duplicate messages may be messages with at least one of the same message type, message identifier, and message content. The message type may be configured to indicate information or signals carried in the message, and the message identifier may be configured to distinguish messages of the same message type.

For example, the duplicate messages may be messages with the same message type, where the message identifiers may be the same or may also be different, and the message content may also be the same or may also be different. For another example, the duplicate messages may be messages with the same message identifier, where the message type may be the same or may also be different, and the message content may also be the same or may also be different. For yet another example, the duplicate messages may be messages with the same message content, where the message type may be the same or may also be different, and the message identifier may also be the same or may also be different. For yet another example, the duplicate messages may be messages with both the same message type and the same message identifier, where the message content may also be the same or may also be different.

The terminal may determine that the second message and the first message are duplicate messages in various ways.

For example, it may be determined that the second message and the first message are duplicate messages, in a case where the message type of the second message is the same as that of the first message.

For another example, it may be determined that the second message and the first message are duplicate messages, in a case where the message identifier of the second message is the same as that of the first message. The message identifier is configured to distinguish different messages.

For yet another example, it may be determined that the second message and the first message are duplicate messages, in a case where the message type of the second message is the same as that of the first message, and the message identifier of the second message is also the same as that of the first message.

For yet another example, it may be determined that the second message and the first message are duplicate messages, in a case where the message type of the second message is the same as that of the first message and a reception time difference between the second message and the first message is less than or equal to a preset time difference threshold. The preset time difference threshold may be any preset time, such as 10 milliseconds, 100 milliseconds or 1 second.

For yet another example, it may be determined that the second message and the first message are duplicate messages, in a case where the message identifier of the first message is the same as that of the second message and the reception time difference between the second message and the first message is less than or equal to the preset time difference threshold.

For yet another example, it may be determined that the second message and the first message are duplicate messages, in a case where the message type and the message identifier of the first message are the same as those of the second message and the reception time difference between the second message and the first message is less than or equal to the preset time difference threshold.

In step S704, the terminal discards one of the duplicate messages.

In some embodiments, the discarded message may be one random message. For example, the terminal may randomly discard one message from the first message and the second message, and retain the other one message.

In other embodiments, the discarded message may be the first message sent by the relay device. For example, the terminal may discard the first message sent by the relay device and retain the second message sent by the network device.

It is to be noted that since the relay device may forward a message sent by the network device, the terminal may prioritize the message sent by the network device and discard the message sent by the relay device, in a case where the duplicate messages are received.

In yet other embodiments, the discarded message may be the second message sent by the network device. For example, the terminal may discard the second message sent by the network device and retain the first message sent by the relay device.

In still other embodiments, the discarded message may be a message whose reception time is earlier than a reception time of a non-discarded message. That is, the reception time of the discarded message may be earlier than the reception time of the non-discarded message. For example, the terminal may discard the earliest received message and retain the latest received message.

Optionally, the terminal may further perform, according to the retained message, an action corresponding to the retained message, such as sending a feedback signal or registering.

It is to be noted that, without any contradiction, the embodiments shown in FIG. 7 may be combined with the aforementioned embodiments or implementations of the present disclosure and their various optional solutions, which are not repeated here.

In this way, the terminal, in a case of receiving the duplicate messages, may choose to discard one of the messages according to different strategies, improving the communication reliability of the terminal.

In some embodiments of the present disclosure, the terminal may receive a third message and a fourth message that are sent by a first device, determine that the third message and the fourth message are duplicate messages, and discard one of the duplicate messages, where the discarded message may be a message whose reception time is earlier than a reception time of a non-discarded message, and the first device may be the relay device or the network device.

It is also to be noted that the duplicate messages may be messages with at least one of the same message type, message identifier and message content. The message type may be configured to indicate information or signals carried in the message, and the message identifier may be configured to distinguish messages of the same message type.

For example, the network device may periodically send system messages. The network device successively sent two system messages (e.g., the third message and the fourth message). However, due to delay or load reasons, the terminal receives the third message and the fourth message in a shorter period of time and processes neither of them. The terminal may determine that the two received system messages are duplicate messages and discard one of the messages using the above-mentioned method. This reduces the message processing load on the terminal.

For another example, after the network device sends the system message (the third message), the system information is updated, and a new system message (the fourth message) is sent again. The message types sent twice are of the same system message type. The terminal may determine that the two received system messages are duplicate messages according to the message type and discard one of the messages using the above-mentioned method. This can reduce the message processing load on the terminal.

The specific manner in which the terminal determines that the third message and the fourth message are duplicate messages may refer to the manner in which the terminal determines that the second message and the first message are duplicate messages in the aforementioned embodiments of the present disclosure, which is not repeated here.

In this way, the terminal, in a case of receiving the duplicate messages sent by the relay device of the network device, may choose to discard one of the messages according to different strategies, improving the communication reliability of the terminal.

FIG. 8 is a flowchart of a method for wireless registration according to an example. The method may be performed by a relay device in the above-mentioned communication system. As shown in FIG. 8, the method may include the following step S801.

In S801, the relay device forwards a wireless signal between a terminal and a network device.

The wireless signal may be configured for the terminal to register, and the relay device may be configured to forward the wireless signal between the terminal equipment and the network equipment.

The terminal may be an ambient IoT device, or may also be other devices capable of communicating with the relay device.

In some embodiments, the terminal may be a passive terminal or a low-power-consumption terminal (for example, it may be a low-power-consumption ambient IoT device, or a passive ambient IoT device). In order to reduce the power consumption and complexity of the terminal, a communication distance that can be supported by the terminal may be less than a distance threshold, where the distance threshold may be any value between 1 meter and 1,000 meters. For example, the distance threshold may be 10 meters, 50 meters, 100 meters or 200 meters.

The terminal may register with the network device via the relay device, or may also communicate with the network device via the relay device, in a case where the communication distance that can be supported by the terminal is less than a distance between the terminal and the network device. Hence, the problem of the terminal being unable to register or communicate due to distance limitations can be solved.

By adopting the above-mentioned method, the relay device may forward the wireless signal between the terminal and the network device, where the wireless signal may be configured for the terminal to register, and the terminal may be an ambient IoT device. In this way, the registration of the terminal is achieved via the relay device, which can support the terminal to register with the network device that is far away, improving the communication reliability of the terminal.

In some embodiments of the present disclosure, the relay device may include a radio-frequency read/write device, where the radio-frequency read/write device may write information to or read information from the terminal based on a radio-frequency read/write manner.

In some embodiments of the present disclosure, the relay device is connected to the network device in a wired or wireless manner, or the relay device is integrated into the network device.

For example, the relay device may include: a radio-frequency read/write device connected to the network device in a wired manner, a radio-frequency read/write device connected to the network device in a wireless manner, or a radio-frequency read/write device integrated into the network device.

In some embodiments of the present disclosure, the relay device may be configured to perform at least one of:
reading information stored in the terminal based on a radio-frequency read/write manner;
writing information to the terminal based on a radio-frequency read/write manner;
sending a wireless signal to the terminal;
receiving a wireless signal sent by the terminal;
receiving a wireless signal sent by the network device;
responding to the wireless signal sent by the network device; or
sending a wireless signal to the network device.

In some embodiments of the present disclosure, by forwarding the wireless signal between the terminal and the network device, the relay device may implement at least one of the following steps.

The relay device receives a trigger signal sent by the network device.

The relay device sends the trigger signal to the terminal.

The relay device receives a trigger feedback signal sent by the terminal.

The relay device sends the trigger feedback signal to the network device.

The relay device obtains a terminal identifier of the terminal. For example, the relay device may receive the terminal identifier sent by the terminal, or the relay device may obtain the terminal identifier of the terminal based on a radio-frequency read/write manner.

The relay device sends the terminal identifier to the network device.

The relay device receives synchronization information sent by the network device.

The relay device sends the synchronization information to the terminal.

The relay device receives a synchronization feedback signal sent by the terminal.

The relay device sends the synchronization feedback signal to the network device.

The relay device receives system information sent by the network device.

The relay device sends the system information to the terminal.

The relay device receives a system information feedback signal sent by the terminal.

The relay device sends the system information feedback signal to the network device.

The relay device receives a termination signaling sent by the network device. The termination signaling is configured to indicate that the relay device ends the registration process, or the termination signaling is configured to indicate that the relay device disconnects the communication connection with the terminal.

In this way, the relay device may perform the registration of the terminal via any one of or a combination of the above-mentioned steps.

In some embodiments of the present disclosure, the relay device may send a first message to the terminal, and the network device may send a second message to the terminal, where the first message and the second message may be duplicate messages. It is to be noted that the first message may carry any information or signal, such as synchronization information, system information, a trigger signal or other registration information or signals. Similarly, the second message may also carry any of the above-mentioned information or signals.

For example, the network device sends the second message, and the relay device, upon receiving the second message, forwards the first message to the terminal (the content of the first message is the same as that of the second message). Both the second message and the first message may be received by the terminal. At this time, the terminal may determine that the second message and the first message are duplicate messages.

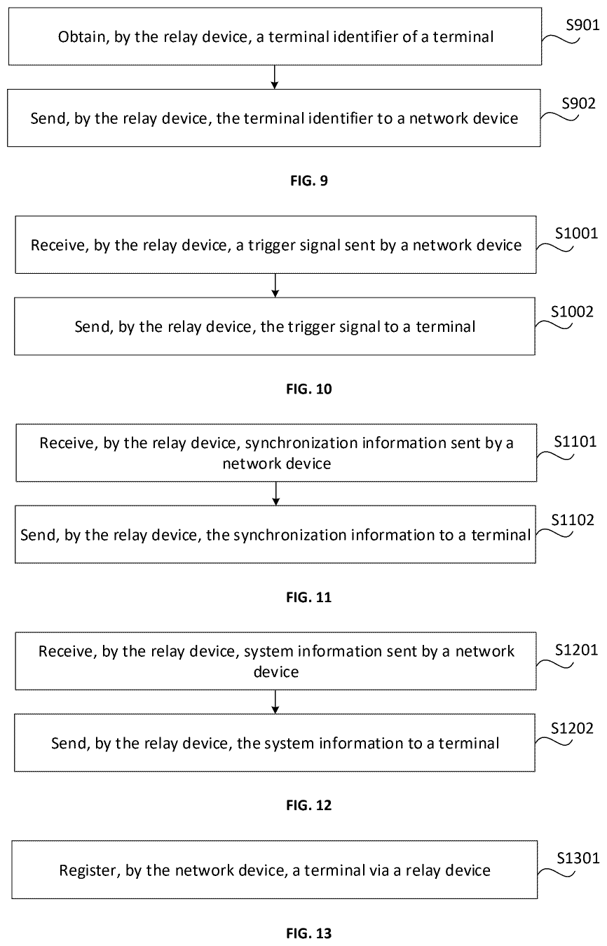

FIG. 9 is a flowchart of a method for wireless registration according to an example. The method may be performed by a relay device in the above-mentioned communication system. As shown in FIG. 9, the method may include the following steps S901 and S902.

In step S901, the relay device obtains a terminal identifier of a terminal.

In some embodiments, the relay device may receive the terminal identifier sent by the terminal. For example, the relay device may receive a trigger signal sent by the terminal, where the trigger signal may include the terminal identifier of the terminal.

In other embodiments, the relay device may obtain the terminal identifier of the terminal based on a radio-frequency read/write manner.

In step S902, the relay device sends the terminal identifier to a network device.

The terminal identifier may be configured for the network device to register the terminal.

In some embodiments, the terminal identifier may be configured to uniquely identify the terminal. For example, the terminal identifier may include at least one of an SUCI, an SUPI, a GUTI, a PEI, an IMEI, an IMSI, a TMSI, an RNTI, or other device identifiers of the terminal.

In other embodiments, the relay device may further obtain device information of the terminal, apart from the terminal identifier, and send the device information to the network device, where the device information may be configured for registration. The device information may include at least one of: a first type of the terminal (for example, the first type may be a passive terminal, an active terminal, or a semi-passive terminal), a second type of the terminal (for example, the second type may be a paper tag, a metal tag, or other types), a device volume of the terminal, a communication distance of the terminal, a communication delay of the terminal, etc.

In some embodiments, the relay device may forward the terminal identifier to the network device, and the network device may register (e.g., authenticate or authorize), according to the terminal identifier, the terminal.

In this way, the relay device may obtain the terminal identifier of the terminal and send the terminal identifier to the network device, and the network device may register, according to the terminal identifier, the terminal.

FIG. 10 is a flowchart of a method for wireless registration according to an example. The method may be performed by a relay device in the above-mentioned communication system. As shown in FIG. 10, the method may include the following steps S1001 and S1002.

In step S1001, the relay device receives a trigger signal sent by a network device.

In step S1002, the relay device sends the trigger signal to a terminal.

The trigger signal is configured to indicate the terminal to perform registration.

In some embodiments, the terminal may send, according to the trigger signal, a terminal identifier of the terminal to the relay device. The relay device may receive the terminal identifier sent by the terminal in response to the trigger signal, and send the terminal identifier to the network device.

In some embodiments, the relay device may further receive a trigger feedback signal sent by the terminal, where the trigger feedback signal is configured to indicate that the terminal has received the trigger signal.

Optionally, the relay device may further send the trigger feedback signal to the network device.

Optionally, the relay device, in a case of receiving the trigger feedback signal, may further obtain at least one of the terminal identifier or device information of the terminal based on a radio-frequency read/write manner, and send at least one of the terminal identifier or device information to the network device.

In this way, the relay device may indicate, via the trigger signal, that the terminal registers.

FIG. 11 is a flowchart of a method for wireless registration according to an example. The method may be performed by a relay device in the above-mentioned communication system. As shown in FIG. 11, the method may include the following steps S1101 and S1102.

In step S1101, the relay device receives synchronization information sent by a network device.

In step S1102, the relay device sends the synchronization information to a terminal.

The synchronization information may include at least one of time-domain synchronization information or frequency-domain synchronization information.

In some embodiments, the terminal may synchronize according to the synchronization information. For example, the terminal may perform time-domain synchronization according to the time-domain synchronization information, or may also perform frequency-domain synchronization according to the frequency-domain synchronization information.

In this way, the relay device may send the synchronization information, so that the terminal may synchronize according to the synchronization information and register or communicate.

In some embodiments, the relay device may further receive a synchronization feedback signal sent by the terminal.

The synchronization feedback signal may be configured to indicate that the terminal has received the synchronization information, or the synchronization feedback signal may be configured to indicate that the terminal has completed the synchronization. For example, the terminal, upon completing the synchronization according to the synchronization information, may send the synchronization feedback signal to the relay device.

Optionally, the relay device may further send a synchronization feedback signal to the network device.

FIG. 12 is a flowchart of a method for wireless registration according to an example. The method may be performed by a relay device in the above-mentioned communication system. As shown in FIG. 12, the method may include the following steps S1201 and S1202.

In step S1201, the relay device receives system information sent by a network device.

In step S1202, the relay device sends the system information to a terminal.

The system information may include network information of a network device, where the network information may include at least one of: cell identifier information, frequency information (e.g., center frequency point, frequency bandwidth, whether frequency hopping is supported, etc.), cell selection information, cell reselection information or network capability information (e.g., whether registration or access of an ambient IoT terminal is supported, whether registration or access of a terminal via a relay device is supported, etc.).

In this way, the relay device may send the system information, so that the terminal registers according to the system information.

In some embodiments, the relay device may further receive a system information feedback signal sent by the terminal, where the system information feedback signal may be configured to indicate that the terminal has received the system information.

Optionally, the relay device may further send the system information feedback signal to the network device.

It is also to be noted that, without any contradiction, the above-mentioned embodiments or implementations of FIGS. 8 to 12, and their various optional solutions may be combined with each other, which is not repeated here.

FIG. 13 is a flowchart of a method for wireless registration according to an example. The method may be performed by a network device in the above-mentioned communication system. As shown in FIG. 13, the method may include the following step S1301.

In step S1301, the network device registers a terminal via a relay device.

In some embodiments, the relay device may be configured to forward a wireless signal between the terminal and the network device, where the wireless signal may be configured for the terminal to register.

In some embodiments, the terminal may be an ambient IoT device, or may also be other devices capable of communicating with the relay device.

By adopting the above-mentioned method, the network device may register the terminal via the relay device, where the relay device may be configured to forward the wireless signal between the terminal and the network device, the wireless signal may be configured for the terminal to register, and the terminal may be an ambient IoT device. In this way, the registration of the terminal is achieved via the relay device, which can support the terminal to register the network device that is far away, improving the communication reliability of the terminal.

In some embodiments of the present disclosure, the process of the terminal registering via the relay device may include at least one of the following steps.

The network device sends a trigger signal to the relay device.

The network device receives a trigger feedback signal sent by the relay device.

The network device receives a terminal identifier sent by the relay device.

The network device sends synchronization information to the relay device.

The network device receives a synchronization information feedback signal sent by the relay device.

The network device sends system information to the relay device.

The network device receives a system information feedback signal sent by the relay device.

The network device sends a termination signal to the relay device.

The network device sends a trigger signal to the terminal.

The network device receives a trigger feedback signal sent by the terminal.

The network device obtains the terminal identifier.

The network device sends the synchronization information to the terminal.

The network device receives a synchronization information feedback signal sent by the terminal. The network device sends the system information to the terminal.

The network device receives a system information feedback signal sent by the terminal.

In this way, the network device may perform registration of the terminal via any one of or a combination of the above-mentioned steps.

In some embodiments of the present disclosure, the relay device may send a first message to the terminal, and the network device may send a second message to the terminal, where the first message and the second message may be duplicate messages. It is to be noted that the first message may carry any information or signal, such as synchronization information, system information, a trigger signal or other registration information or signals. Similarly, the second message may also carry any of the above-mentioned information or signals.

For example, the network device sends the second message, and the relay device, upon receiving the second message, forwards the first message to the terminal (the content of the first message is the same as that of the second message). Both the second message and the first message may be received by the terminal. At this time, the terminal may determine that the second message and the first message are duplicate messages.

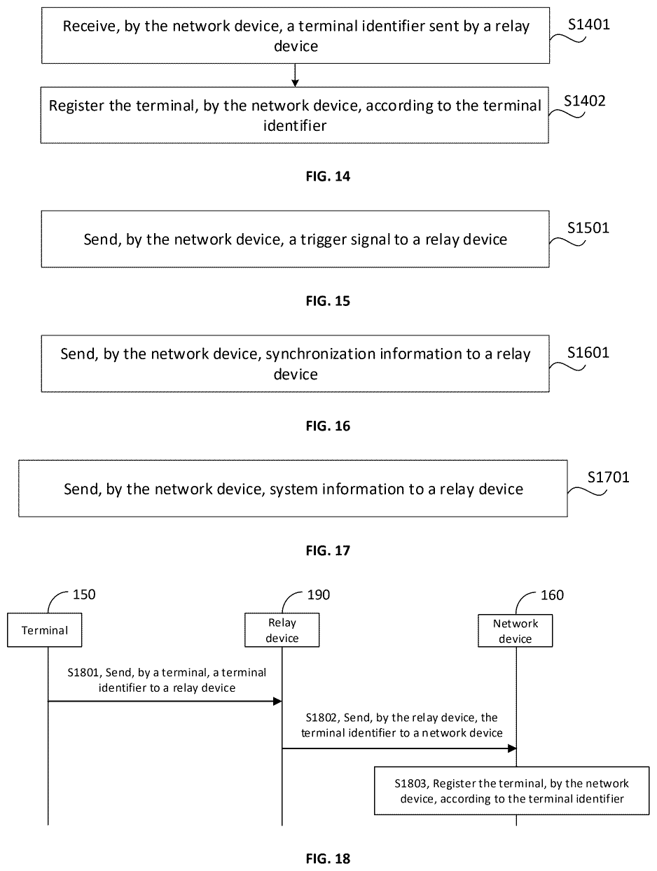

FIG. 14 is a flowchart of a method for wireless registration according to an example. The method may be performed by a network device in the above-mentioned communication system. As shown in FIG. 14, the method may include the following steps S1401 and S1402.

In step S1401, the network device receives a terminal identifier sent by a relay device.

The terminal identifier may be an identifier of a terminal.

In some embodiments, the terminal identifier may be configured to uniquely identify the terminal. For example, the terminal identifier may include at least one of an SUCI, an SUPI, a GUTI, a PEI, an IMEI, an IMSI, a TMSI, an RNTI, or other device identifiers of the terminal.

In step S1402, the network device registers, according to the terminal identifier, the terminal.

For example, the network device may authenticate or authorize, according to the terminal identifier, the terminal to complete the registration of the terminal.

In some embodiments, the terminal identifier may be an identifier sent by the terminal to the relay device.

In other embodiments, the terminal identifier may be an identifier of the terminal obtained by the relay device based on a radio-frequency read/write manner.

In some embodiments, the network device may also directly receive the terminal identifier sent by the terminal.

In this way, the network device may obtain the terminal identifier of the terminal and register, according to the terminal identifier, the terminal.

FIG. 15 is a flowchart of a method for wireless registration for registering according to an example. The method may be performed by a network device in the above-mentioned communication system. As shown in FIG. 15, the method may include the following step S1501.

In step S1501, the network device sends a trigger signal to a relay device.

The trigger signal may be configured to indicate that a terminal registers.

In some embodiments, the terminal may send, according to the trigger signal, a terminal identifier of the terminal to the relay device. The relay device may receive the terminal identifier sent by the terminal in response to the trigger signal, and send the terminal identifier to the network device.

Optionally, the network device may further receive a trigger feedback signal sent by the relay device, where the trigger feedback signal may be configured to indicate that the terminal has received the trigger signal.

In some embodiments, the network device may also directly send the trigger signal to the terminal. Similarly, the network device may also directly receive a trigger feedback signal sent by the terminal.

In this way, the network device may indicate, via the trigger signal, that the terminal registers.

FIG. 16 is a flowchart of a method for wireless registration according to an example. The method may be performed by a network device in the above-mentioned communication system. As shown in FIG. 16, the method may include the following step S1601.

In step S1601, the network device sends synchronization information to a relay device.

The synchronization information may include at least one of time-domain synchronization information or frequency-domain synchronization information.

In some embodiments, a terminal may synchronize according to the synchronization information. For example, the terminal may perform time-domain synchronization according to the time-domain synchronization information, or may also perform frequency-domain synchronization according to the frequency-domain synchronization information.

Optionally, the network device may further receive a synchronization feedback signal sent by the relay device, where the synchronization feedback signal may be configured to indicate that the terminal has received the synchronization information.

In some embodiments, the network device may also directly send synchronization information to the terminal. Similarly, the network device may also directly receive a synchronization information feedback signal sent by the terminal.

In this way, the network device may send synchronization information, so that the terminal may synchronize according to the synchronization information and register or communicate.

FIG. 17 is a flowchart of a method for wireless registration for according to an example. The method may be performed by a network device in the above-mentioned communication system. As shown in FIG. 17, the method may include the following step S1701.

In step S1701, the network device sends system information to a relay device.

The system information may include network information of a network device, where the network information may include at least one of following: cell identifier information, frequency information (e.g., center frequency point, frequency bandwidth, whether frequency hopping is supported, etc.), cell selection information, cell reselection information or network capability information (e.g., whether registration or access of an ambient IoT terminal is supported, whether registration or access of a terminal via a relay device is supported, etc.).

Optionally, the network device may further receive a system information feedback signal sent by the relay device, where the system information feedback signal is configured to indicate that a terminal has received the system information.

In some embodiments, the network device may also directly send system information to the terminal. Similarly, the network device may also directly receive a system information feedback signal sent by the terminal.

In this way, the network device may send the system information, so that the terminal registers according to the system information.

It is also to be noted that, without any contradiction, the above-mentioned embodiments or implementations of FIGS. 13 to 17 and their various optional solutions may be combined with each other, which is not repeated here.

FIG. 18 is a flowchart of a method for wireless registration according to an example. As shown in FIG. 18, the method may include the following steps S1801 to S1803.

In step S1801, a terminal sends a terminal identifier to a relay device.

In step S1802, the relay device sends the terminal identifier to a network device.

In step S1803, the network device registers, according to the terminal identifier, the terminal.

In some embodiments, the network device may send a trigger signal to the relay device, and the relay device may send the trigger signal to the terminal.

Optionally, the terminal may send a trigger feedback signal to the relay device in response to the trigger signal, and the relay device may also send the trigger feedback signal to the network device.

In some embodiments, the network device may send synchronization information to the relay device, and the relay device may send the synchronization information to the terminal.

Optionally, the terminal may send a synchronization information feedback signal to the relay device in response to the trigger signal, and the relay device may also send the synchronization information feedback signal to the network device.

In some embodiments, the network device may send system information to the relay device, and the relay device may send the system information to the terminal.

Optionally, the terminal may send a system information feedback signal to the relay device in response to the trigger signal, and the relay device may also send the system information feedback signal to the network device.

In some embodiments, the relay device may send a first message to the terminal; the network device may send a second message to the terminal; and the terminal may receive the first message and the second message, determine that the second message and the first message are duplicate messages, and discard one of the duplicate messages, where the discarded message may be the first message sent by the relay device, or the discarded message may also be a message whose reception time is earlier than a reception time of a non-discarded message.

In some embodiments, a first device may send a third message and a fourth message to the terminal; and the terminal may receive the third message and the fourth message, determine that the third message and the fourth message are duplicate messages, and discard one of the duplicate messages, where the discarded message may also be a message whose reception time is earlier than a reception time of a non-discarded message, and the first device may be a relay device or a network device.

It is to be noted that, without any contradiction, this embodiment may be combined with the aforementioned embodiments or implementations of the present disclosure and their various optional solutions, and the specific implementations of the above-mentioned steps in this embodiment may also refer to the description in the aforementioned embodiments of the present disclosure, which is not repeated here.

In this way, the terminal may register via the relay device.

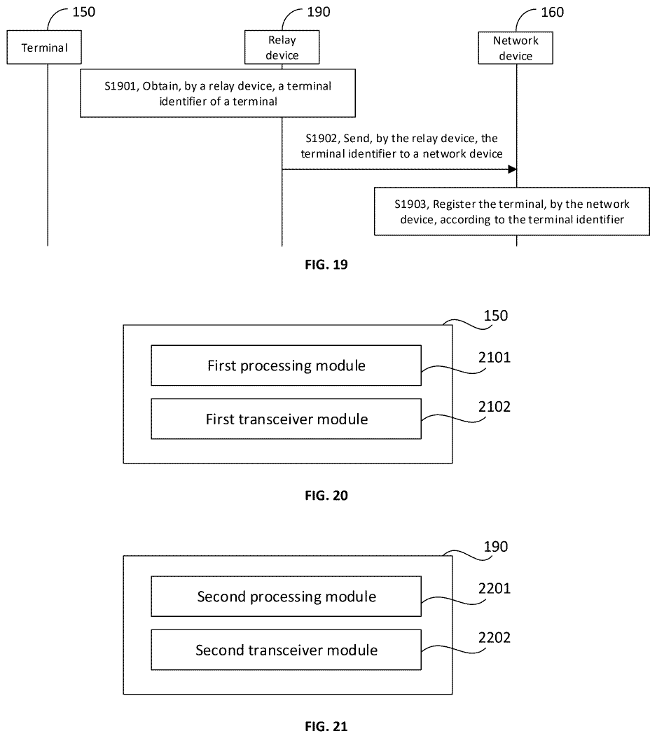

FIG. 19 is a flowchart of a method for wireless registration according to an example. As shown in FIG. 19, the method may include the following steps S1901 to S1903.

In step S1901, a relay device obtains a terminal identifier of a terminal.

In some embodiments, the relay device may receive the terminal identifier sent by the terminal. In other embodiments, the relay device may obtain the terminal identifier of the terminal based on a radio-frequency read/write manner.

In step S1902, the relay device sends the terminal identifier to a network device.

In step S1903, the network device registers, according to the terminal identifier, the terminal.

In some embodiments, the network device may send a trigger signal to the relay device, and the relay device may send the trigger signal to the terminal.

Optionally, the terminal may send a trigger feedback signal to the relay device in response to the trigger signal, and the relay device may also send the trigger feedback signal to the network device.

In some embodiments, the network device may send synchronization information to the relay device, and the relay device may send the synchronization information to the terminal.

Optionally, the terminal may send a synchronization information feedback signal to the relay device in response to the trigger signal, and the relay device may also send the synchronization information feedback signal to the network device.

In some embodiments, the network device may send system information to the relay device, and the relay device may send the system information to the terminal.

Optionally, the terminal may send a system information feedback signal to the relay device in response to the trigger signal, and the relay device may also send the system information feedback signal to the network device.

It is to be noted that, without any contradiction, this embodiment may be combined with the aforementioned embodiments or implementations of the present disclosure and their various optional solutions, and the specific implementations of the above-mentioned steps in this embodiment may also refer to the description in the aforementioned embodiments of the present disclosure, which is not repeated here.

In this way, the terminal may register via the relay device.

In an example, the present disclosure further provides a communication system. The communication system may include a terminal, a relay device and a network device, where the terminal may perform the method for wireless registration performed by the terminal in the aforementioned embodiments of the present disclosure, the relay device may perform the method for wireless registration performed by the relay device in the aforementioned embodiments of the present disclosure, and the network device may perform the method for wireless registration performed by the network device in the aforementioned embodiments of the present disclosure.

FIG. 20 is a block diagram of a terminal according to an example. As shown in FIG. 20, the terminal 150 may include:
a first processing module 2101 configured to register via a relay device, where the relay device is configured to forward a wireless signal between the terminal and a network device, the wireless signal is configured for the terminal to register, and the terminal is an ambient IoT device.

In some embodiments, the first processing module 2101 is configured to send a terminal identifier of the terminal to the relay device.

In some embodiments, the first processing module 2101 is configured to receive a trigger signal sent by the relay device, where the trigger signal is configured to indicate the terminal to perform registration; and register according to the trigger signal.

In some embodiments, the first processing module 2101 is configured to send, according to the trigger signal, a terminal identifier of the terminal to the relay device, where the terminal identifier is configured for the network device to register the terminal; or
transmit, according to the trigger signal, the terminal identifier to the relay device based on a radio-frequency read/write manner.

In some embodiments, the terminal further includes:
a first transceiver module 2102 configured to send a trigger feedback signal to the relay device, where the trigger feedback signal is configured to indicate that the terminal has received the trigger signal.

In some embodiments, the first transceiver module 2102 is further configured to receive synchronization information sent by the relay device, where the synchronization information includes at least one of time-domain synchronization information or frequency-domain synchronization information.

In some embodiments, the first transceiver module 2102 is further configured to send a synchronization feedback signal to the relay device, where the synchronization feedback signal is configured to indicate that the terminal has received the synchronization information.

In some embodiments, the first transceiver module 2102 is further configured to receive system information sent by the relay device.

In some embodiments, the first transceiver module 2102 is further configured to send a system information feedback signal to the relay device, where the system information feedback signal is configured to indicate that the terminal has received the system information.

In some embodiments, the first transceiver module 2102 is further configured to receive a first message sent by the relay device and receive a second message sent by the network device.

The first processing module 2101 is further configured to determine that the second message and the first message are duplicate messages and discard one of the duplicate messages, where the discarded message is the first message sent by the relay device, or a reception time of the discarded message is earlier than a reception time of a non-discarded message.

In some embodiments, the first transceiver module 2102 is further configured to receive a third message and a fourth message that are sent by a first device, where the first device is a relay device or a network device.

The first processing module 2101 is further configured to determine that the third message and the fourth message are duplicate messages; and discard one of the duplicate messages, where the discarded message is a message whose reception time is earlier than the reception time of the non-discarded message.

FIG. 21 is a block diagram of a relay device according to an example. As shown in FIG. 21, the relay device 190 may include:
a second processing module 2201 configured to forward a wireless signal between a terminal and a network device, where the wireless signal is configured for the terminal to register.

In some embodiments, the second processing module 2201 is configured to obtain a terminal identifier of the terminal; and send the terminal identifier to the network device, where the terminal identifier is configured for the network device to register the terminal.

In some embodiments, the second processing module 2201 is configured to receive the terminal identifier sent by the terminal or obtain the terminal identifier of the terminal based on a radio-frequency read/write manner.

In some embodiments, the second processing module 2201 is configured to receive a trigger signal sent by the network device; and send the trigger signal to the terminal, where the trigger signal is configured to indicate the terminal to perform registration.

In some embodiments, the relay device further includes:
a second transceiver module 2202 configured to receive a trigger feedback signal sent by the terminal, where the trigger feedback signal is configured to indicate that the terminal has received the trigger signal and send the trigger feedback signal to the network device.

In some embodiments, the second transceiver module 2202 is further configured to receive synchronization information sent by the network device, where the synchronization information includes at least one of time-domain synchronization information or frequency-domain synchronization information; and send the synchronization information to the terminal.

In some embodiments, the second transceiver module 2202 is further configured to receive a synchronization feedback signal sent by the terminal, where the synchronization feedback signal is configured to indicate that the terminal has received the synchronization information; and send the synchronization feedback signal to the network device.

In some embodiments, the second transceiver module 2202 is further configured to receive system information sent by the network device and send the system information to the terminal.

In some embodiments, the second transceiver module 2202 is further configured to receive a system information feedback signal sent by the terminal, where the system information feedback signal is configured to indicate that the terminal has received the system information; and send the system information feedback signal to the network device.

In some embodiments, the relay device includes a radio-frequency read/write device, where the radio-frequency read/write device writes information to or reads information from the terminal based on a radio-frequency read/write manner.

In some embodiments, the relay device is connected to the network device in a wired or wireless manner, or the relay device is integrated into the network device.

In some embodiments, the relay device is further configured for at least one of:
sending a wireless signal to the terminal;
receiving a wireless signal sent by the terminal;
receiving a wireless signal sent by the network device; or
sending a wireless signal to the network device.

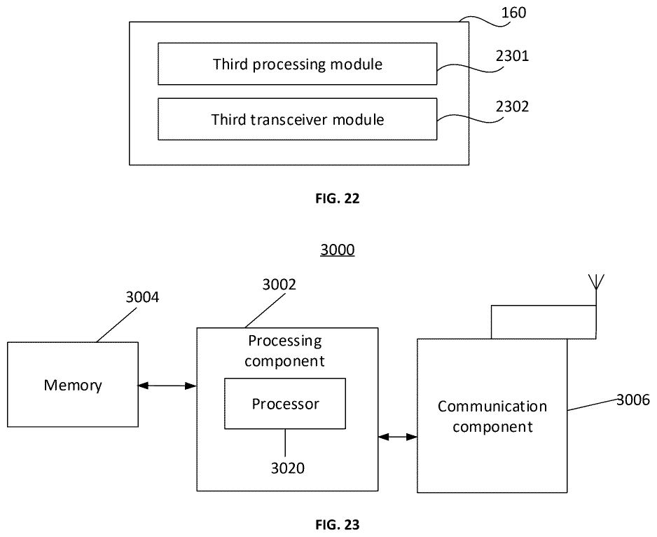

FIG. 22 is a block diagram of a network device according to an example. As shown in FIG. 22, the network device 160 may include:
a third processing module 2301 configured to register a terminal via a relay device, where the relay device is configured to forward a wireless signal between the terminal and the network device, and the wireless signal is configured for the terminal to register.

In some embodiments, the third processing module 2301 is configured to receive a terminal identifier sent by the relay device, where the terminal identifier is an identifier of the terminal; and register, according to the terminal identifier, the terminal.

In some embodiments, the terminal identifier is an identifier sent by the terminal to the relay device, or the terminal identifier is an identifier of the terminal obtained by the relay device based on a radio-frequency read/write manner.

In some embodiments, the third processing module 2301 is configured to send a trigger signal to the relay device, where the trigger signal is configured to indicate the terminal to perform registration.

In some embodiments, the network device further includes:
a third transceiver module 2302 configured to receive a trigger feedback signal sent by the relay device, where the trigger feedback signal is configured to indicate that the terminal has received the trigger signal.

In some embodiments, the third transceiver module 2302 is further configured to send synchronization information to the relay device, where the synchronization information includes at least one of time-domain synchronization information or frequency-domain synchronization information.

In some embodiments, the third transceiver module 2302 is further configured to receive a synchronization feedback signal sent by the relay device, where the synchronization feedback signal is configured to indicate that the terminal has received the synchronization information.

In some embodiments, the third transceiver module 2302 is further configured to send system information to the relay device.

In some embodiments, the third transceiver module 2302 is further configured to receive a system information feedback signal sent by the relay device, where the system information feedback signal is configured to indicate that the terminal has received the system information.

For the device in the above-mentioned embodiments, the specific manner in which each module performs operations has been described in detail in the embodiments related to the method, which will not be repeated here.

FIG. 23 is a block diagram of a device for wireless registration according to an example. The device for wireless registration 3000 may be a terminal, a relay device or a network device in the communication system shown in FIG. 1.

Referring to FIG. 23, the device 3000 may include one or more of the following components: a processing component 3002, a memory 3004, and a communication component 3006.

The processing component 3002 can be configured to control the overall operation of the device 3000, such as operations associated with display, phone calls, data communications, camera operations, and recording operations. The processing component 3002 may include one or more processors 3020 to execute instructions to complete all or part of the steps of the above-mentioned method for wireless registration. Additionally, the processing component 3002 may include one or more modules to facilitate interaction between the processing component 3002 and other components. For example, the processing component 3002 may include a multimedia module to facilitate interaction between the multimedia component and the processing component 3002.

The memory 3004 is configured to store various types of data to support the operations of the device 3000. Examples of such data include instructions for any application or method operating on the device 3000, contact data, phonebook data, messages, pictures, videos, etc. The memory 3004 can be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 3006 is configured to facilitate communication between the device 3000 and other devices in a wired or wireless manner. The device 3000 can access a wireless network based on a communication standard, such as Wi-Fi, 2G, 3G, 4G, 5G, 6G, NB-IOT, eMTC, or a combination of them. In one example, the communication component 3006 receives a broadcast signal or broadcast-related information from an external broadcast management system via a broadcast channel. In one example, the communication component 3006 further includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology, and other technologies.

In an example, the device 3000 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above-mentioned method for wireless registration.

The above-mentioned device 3000 may be a standalone electronic device or may also be part of a standalone electronic device. For example, in one embodiment, the electronic device may be an integrated circuit (IC) or chip, where the integrated circuit may be one IC or may also be a set of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SOC), etc. The above-mentioned integrated circuit or chip can be configured to execute executable instructions (or codes) to implement the above-mentioned method for wireless registration. The executable instructions may be stored in the integrated circuit or chip, or may also be obtained from other devices or equipment. For example, the integrated circuit or chip includes a processor, a memory, and an interface for communicating with other devices. The executable instructions may be stored in the processor, and when executed by the processor, implement the above-mentioned registration; or the integrated circuit or chip may receive the executable instructions via the interface and transmit them to the processor for execution to implement the above-mentioned method for wireless registration.

In an example, the present disclosure further provides a computer-readable storage medium storing computer program instructions, where the program instructions, when executed by a processor, implement the steps of the method for wireless registration provided by the present disclosure. For example, the computer-readable storage medium may be a non-transitory computer-readable storage medium including instructions, such as the above-mentioned memory 3004, including instructions, where the above-mentioned instructions can be executed by the processor 3020 of the device 3000 to complete the above-mentioned method for wireless registration. For example, the non-transitory computer-readable storage medium may be a ROM, a random access memory (RAM), a CD-ROM, a magnetic tape, a floppy disk, an optical data storage device, etc.

As used herein, the term processor may refer to one processor that performs the defined functions or a plurality of processors that collectively perform defined functions, such that the execution of the individual defined functions may be divided amongst such processors. In another example, a computer program product is further provided, including a computer program capable of being executed by a programmable device. The computer program has a code portion for performing the above-mentioned method for wireless registration when executed by the programmable device.

Those skilled in the art will readily think of other embodiments of the disclosure upon considering the specification and practicing the present disclosure. This application is intended to cover any variations, uses, or adaptations of the present disclosure. These variations, uses, or adaptations follow the general principles of the present disclosure and include common knowledge or conventional techniques in the technical field that are not disclosed in the present disclosure. The specification and the embodiments are to be considered as illustrative merely, and the true scope and spirit of the present disclosure are indicated by the following claims.

It is to be understood that the present disclosure is not limited to the precise structure described above and shown in the accompanying drawings, and various modifications and changes can be made without departing from its scope. The scope of the present disclosure is limited merely by the appended claims.

1. A registration method for wireless registration performed by a terminal, the method comprising:
registering via a relay device, wherein the relay device is configured to forward a wireless signal between the terminal and a network device, the wireless signal is configured for the terminal to register, and the terminal is an ambient internet of things device.

2. The method according to claim 1, wherein registering via the relay device comprises:
sending a terminal identifier of the terminal to the relay device.

3. The method according to claim 1, wherein registering via the relay device comprises:
receiving a trigger signal sent by the relay device, wherein the trigger signal is configured to indicate the terminal to perform registration; and
registering according to the trigger signal.

4. The method according to claim 3, wherein registering according to the trigger signal comprises:
sending, according to the trigger signal, a terminal identifier of the terminal to the relay device, wherein the terminal identifier is configured for the network device to register the terminal; or
transmitting, according to the trigger signal, the terminal identifier to the relay device based on a radio-frequency read/write manner.

5. The method according to claim 3, further comprising:
sending a trigger feedback signal to the relay device, wherein the trigger feedback signal is configured to indicate that the terminal has received the trigger signal.

6. The method according to claim 1, further comprising:
receiving synchronization information sent by the relay device, wherein the synchronization information comprises at least one of time-domain synchronization information or frequency-domain synchronization information.

7.-11. (canceled)

12. A method for wireless registration, performed by a relay device, the method comprising:
forwarding a wireless signal between a terminal and a network device, wherein the wireless signal is configured for the terminal to register.

13. The method according to claim 12, wherein forwarding the wireless signal between terminal and the network device comprises:
obtaining a terminal identifier of the terminal; and
sending the terminal identifier to the network device, wherein the terminal identifier is configured for the network device to register the terminal.

14. The method according to claim 13, wherein obtaining the terminal identifier of the terminal comprises:
receiving the terminal identifier sent by the terminal; or
obtaining the terminal identifier of the terminal based on a radio-frequency read/write manner.

15. The method according to claim 12, wherein forwarding the wireless signal between the terminal and the network device comprises:
receiving a trigger signal sent by the network device; and
sending the trigger signal to the terminal, wherein the trigger signal is configured to indicate that the terminal to perform registration.

16. The method according to claim 15, further comprising:
receiving a trigger feedback signal sent by the terminal, wherein the trigger feedback signal is configured to indicate that the terminal has received the trigger signal; and
sending the trigger feedback signal to the network device.

17.-20. (canceled)

21. The method according to claim 12, wherein the relay device comprises a radio-frequency read/write device, the radio-frequency read/write device writes information to or reads information from the terminal based on a radio-frequency read/write manner.

22. The method according to 12, wherein the relay device is connected to the network device in a wired or wireless manner; or the relay device is integrated into the network device.

23. (canceled)

24. A method for wireless registration, performed by a network device, the method comprising:
registering a terminal via a relay device, wherein the relay device is configured to forward a wireless signal between the terminal and the network device, and the wireless signal is configured for the terminal to register.

25. The method according to claim 24, wherein registering the terminal via the relay device comprises:
receiving a terminal identifier sent by the relay device, wherein the terminal identifier is an identifier of the terminal; and
registering, according to the terminal identifier, the terminal.

26. The method according to claim 25, wherein the terminal identifier is an identifier sent by the terminal to the relay device; or the terminal identifier is an identifier of the terminal obtained by the relay device based on a radio-frequency read/write manner.

27. The method according to claim 25, wherein registering the terminal via the relay device comprises:
sending a trigger signal to the relay device, wherein the trigger signal is configured to indicate the terminal to perform registration.

28. The method according to claim 27, further comprising:
receiving a trigger feedback signal sent by the relay device, wherein the trigger feedback signal is configured to indicate that the terminal has received the trigger signal.

29.-35. (canceled)

36. A terminal, wherein the terminal comprises:
one or more processors; and
a memory that stores processor-executable instructions,
wherein
the processor-executable instructions, when collectively executed by the one or more processors, cause the terminal to perform the method according to claim 1.

37-38. (canceled)

39. A relay device, wherein the relay device comprises:
one or more processors; and
a memory that stores processor-executable instructions,
wherein the processor-executable instructions, when collectively executed by the one or more processors, cause the relay device to perform the method according to claim 12.

40. A network device, wherein the network device comprises:
one or more processors; and
a memory that stores processor-executable instructions,
wherein the processor-executable instructions, when collectively executed by the one or more processors, cause the network device to perform the method according to claim 24.
